(19) United States
(12) Patent Application Publication
(10) Pub. No.: US 2007/0001151 A1
(43) Pub. Date: Jan. 4, 2007

(54) Organic materials with tunable electric and electroluminescent properties

(76) Inventors: Linda Susan Sapochak, Kennewick, WA (US); Paul Edward Burrows, Kennewick, WA (US); Asanga Bimalchandra Padmaperuma, Richland, WA (US); Murukkuwadura Aruni De Silva, West Lafayette, IN (US); Byron Lee Bennett, Las Vegas, NV (US)

Correspondence Address: Douglas E. McKinley, Jr.;McKinley Law Office, P.O. Box 202, Richland, WA, 99352, US

(21) Appl. No.: 11/035,379

(22) Filed: Jan. 12, 2005

(51) Int. Cl. H01B 1/12

(52) U.S. Cl. 252/500

(57) ABSTRACT

A new class of materials for use in electric and electroluminescent devices having one or more phosphine oxide moieties bonded by single bonds to two outer groups. In embodiments having two or more phosphine oxide moieties, the two or more phosphine oxide moieties are further joined by a bridging group. By selecting appropriate bridging and outer groups, the new class of materials of the present invention enables designers to “tune” the electrical and electroluminescent characteristics of the materials. The phosphine oxide moiety restricts electron conjugation between the bridging and outer groups, isolating the bridging and outer groups from each other, and allowing the photophysical properties of the bridging and outer groups to be maintained in the molecule. The lowest energy component (bridging group or particular outer group) thus defines the triplet state, highest occupied molecular orbital and lowest unoccupied molecular energies for the entire molecule.

### STATEMENT REGARDING FEDERALLY SPONSORED RESEARCH OR DEVELOPMENT

This invention was made with Government support under Contract DE-AC0676RLO1830 awarded by the U.S. Department of Energy and Grant DMR-9874765 awarded by the National Science Foundation. The Government has certain rights in the invention.

### CROSS-REFERENCE TO RELATED APPLICATIONS

Not Applicable

### BACKGROUND OF THE INVENTION

Materials with charge transporting and electroluminescent properties have been successfully deployed in applications covering virtually the entire range of human activity. For example, charge transporting materials are used in photovoltaic devices to generate electricity, electroluminescent devices to produce light, and thin film transistors to control electronic logic devices. While the different applications have grown to include a broad range of manufactured products, a few fundamental features remain common to all such devices. For example, virtually all electronic devices make use of materials which behave in a predictable manner when a voltage is applied across the material, or which produce a predictable voltage when the material is exposed to a predetermined external stimulus. Similarly, virtually all electroluminescent devices make use of materials which produce a predictable luminescent response when exposed to an external stimulus, such as an applied voltage.

The wide variety of uses to which these materials have been successfully deployed has created the need for an equally broad range of properties inherent in the materials. As a result, a great many materials used in these applications have been exhaustively evaluated with respect to their chemical, electrical, and physical properties. Accordingly, the desire to develop new electric and electroluminescent systems and subsystems, and to improve existing electric and electroluminescent systems and subsystems, often requires the development of entirely new materials that will provide properties, or combinations of properties, previously not available to developers.

For a variety of reasons, organic materials have attracted a great deal of interest by designers seeking to develop such new materials. In addition to providing unique chemical or physical properties which may be useful in electric and electroluminescent applications, organic materials often lend themselves to manufacturing processes that are readily adapted to large scales with little or no loss in precision, they may be engineered into an infinite variety of forms, and they often may be manufactured using inexpensive and abundant precursors. For all of these reasons, the development of novel and useful forms of organic materials for use in electrical and electroluminescent applications continues to attract investigation from governmental, educational and industrial researchers across the world.

One example of such research is a result of the desire for solid state white lights that provide high power conversion efficiency. This goal has led to the investigation of organic light emitting devices (OLEDs) designed to simultaneously provide high quantum efficiency and low operating voltage. One approach to this problem is described in the papers “Three-color, tunable, organic light-emitting devices”, published in Science 1997, 276, 2009 by Shen, Z.; Burrows, P. E.; Bulovic, V.; Forrest, S. R.; and Thompson, M. E., and “White-light-emitting organic electroluminescent devices based on interlayer sequential energy transfer,” published in Appl. Phys. Lett. 1999, 75, 888, by Deshpande, R. S.; Bulovic, V.; and Forrest, S. R. In these papers, materials and techniques are described that seek to produce white light by superposition of different types of OLED materials that are red, blue and green emitters, respectively. Another approach seeking the same goal but using different organic materials seeks to produce white light by fluorescent downconversion of blue light by a thin film fluorescent medium. This approach is described in the paper “Organic light-emitting devices for illumination quality white light,” Appl. Phys. Lett. 2002, 80, 3470 by Duggal, A. R.; Shiang, J. J.; Heller, C. M.; and Foust, D. F. Yet another approach using yet another configuration of organic materials seeks the development of a white emitting layer having blue, red and green organo metallic phosphors doped into an inert matrix. This approach is described in the paper “Efficient organic electrophosphorescent white light emitting device with a triple doped emissive layer,” Adv. Mater. 2004, 16, 624 by D'Andrade, B. W.; Holmes R. J.; and Forrest, S. R. These, and all other papers, patents, publications and other written works referenced herein, are hereby incorporated in their entirety by this reference.

While these approaches have yielded interesting and useful results, in all cases, the most efficient materials on the basis of photons generated per electron injected (the quantum efficiency) are organometallic phosphors (typically Ir and Pt-based) doped into organic host matrices. However, the power efficiency of these systems is hampered by their high operating voltages relative to the photon energy generated. Competing systems based on spin-coated or printed polymeric light emitters generally have lower quantum efficiency than small molecule organometallic phosphors, but operate at lower voltages and are therefore competitive on the basis of power efficiency. Combining the advantages of polymer and small molecule devices into an extremely high power efficiency package requires new materials development.

The prior art white light devices described above are all limited by the efficiency of the generation of blue light. The lack of efficient long-lived blue OLEDs also limits the overall efficiency of R-G-B displays. While organometallic phosphor doped OLEDs have demonstrated high quantum efficiencies (˜90% internal) for green devices, operating voltages are still high (˜10 V at high brightness) for all colors compared to polymer based OLEDs, and stable, saturated blue light, critical for good white light with high color rendering index, has not yet been optimized. Blue phosphorescent OLEDs are currently limited by the lack of efficient charge transport layers into which to dope the phosphorescent emitter; to accomplish this, the triplet excited state of those materials must be engineered to be higher than those of the dopants. Currently available materials do not presently operate at optimum efficiency due to inefficient charge transport which leads to higher operating voltage. New host materials are therefore needed that maintain high quantum efficiencies and realize lower operating voltages, which is particularly challenging for blue OLEDs

Typically, organometallic phosphors are doped into a conductive host matrix and emission results from energy transfer from the host to the triplet state of the phosphor. Development of efficient blue OLEDs based on this technology has been particularly challenging because the host material must exhibit triplet level emission ≦450 nm to achieve efficient energy transfer without sacrificing charge transporting properties. Current host materials, such as aromatic dicarbazoles, cannot be engineered to meet these requirements, because as the bandgap and the triplet state energy of the material is increased, the highest occupied molecular orbital (HOMO) and the lowest unoccupied molecular orbital (LUMO) shift in such as way as to enhance undesirable energy and electron transfer pathways between phosphor dopant and host thereby lowering device efficiency and increasing operating voltages. Deeper blue electrophosphorescent OLEDs have only been demonstrated by doping organometallic phosphors into an insulating, wide bandgap host material with charge transport occurring via hopping between adjacent dopant molecules, as discussed in Ren, X.; Li, J.; Holmes, R. J.; Durovich, P. I.; Forrest, S. R.; Thompson, M. E. Chem. Mater. 2004, 16, 4743. This leads to high voltage, and therefore less efficient devices. Thus, there remains a general need for new materials with new combinations of chemical, electrical, and physical properties, and a more specific need for new wide bandgap charge transporting materials, including but not limited to OLED materials that efficiently emit blue light at lower voltages.

### BRIEF SUMMARY OF THE INVENTION

Accordingly, it is a general object of the present invention to provide a new class of materials for use in electric and electroluminescent devices. These materials are generally described as organic materials with one or more phosphine oxide moieties. Generally, it is preferred that two or more phosphine oxide moieties are utilized, and that these phosphine oxide moieties are joined by a bridging group. Each of the phosphine oxide moeities is further bonded by single bonds to at least two outer groups. The outer groups may be linked or bonded to one and another, thereby approximating a single group or a ring, however for purposes of this disclosure they are still referred to as two outer groups, since they are bonded to the phosphine oxide via two single bonds. Outer groups, as the term is used herein, are bound to a single phosphine oxide moiety. Bridging groups, as the term is used herein, are bound to two or more phosphine oxide moieties. The entire molecule; the one or more phosphine oxide moieties, the bridging group, and the two outer groups (whether bonded together or not bonded), is hereinafter referred to as a “phosphine oxide.” Examples of the general structure of the present invention are shown in FIGS. 1 and 2. A single phosphine oxide moiety is shown in FIG. 1, and examples of a di-bonded and a tri-bonded phosphine oxide moiety are shown in FIG. 2. As shown in FIG. 2, the phosphine oxide structures of the present invention can generally be used in oligomer and polymer structures as indicated by the subscript “n” in FIG. 2. As will be recognized by those having skill in the art, this definition would therefore include diphosphine oxide, triphosphine oxide, and other polyphosphine oxides. Further, the bridging groups themselves may contain phosphine oxides.

The phosphine oxides of the present invention are further purified and configured as part of a circuit. As used herein, the phrase “configured as part of a circuit” means that the phosphine oxides are configured to be exposed to an external stimulus, including but not limited to an electrical current, a voltage, a light source, or a temperature gradient. When the materials are exposed to an external stimulus, a predictable response is elicited. Thus, the present invention is a new class of materials, which, in part, are defined by their electrical and electroluminescent properties, and these properties are thus a fundamental aspect of the invention. Preferred embodiments of the present invention include circuits utilizing the materials of the present invention as an OLED, a photodetector, a solar cell, a thin film transistor, a bipolar transistor, and wherein the circuit is incorporated in an array to form an information display. For example, in an OLED, the novel materials could potentially function in an electron transporting layer, a hole blocking layer, an exciton blocking layer, a host layer which either emits light or transfers energy to a light emitting dopant, or a combination of any of the four. In a transistor, either bipolar or thin film, the material would function as the charge transporting active semiconductor layer in a similar manner to doped silicon in a conventional field effect transistor. In a solar cell, the material would function as a charge transporting or exciton blocking layer.

As stated above, it is a critical aspect of the present invention that the materials be purified. Only phosphine oxides that are substantially purified will exhibit the electrical and electroluminescent properties which define the materials of the present invention. While not meant to be limiting, some stages of the purification process are generally performed when the materials are synthesized. A variety of techniques are known that produce phosphines which are typically used as precursors of the present invention. Either when formed, or when utilized in an application, it is typical that one or both of the phosphine groups formed by these methods will eventually be oxidized, thereby producing a mixture of the phosphine oxide, partially oxidized phosphine oxide, and phosphine (i.e., no phosphine moieties oxidized) species. To purify these mixtures, any technique that effectively separates the three species, such as chromatographic separation or successive sublimation of each of the species, is in theory acceptable. However, in practice, successive sublimation is preferred. “Successive sublimation” simply means sublimating the various species one at a time under vacuum, taking advantage of the fact that typically the phosphine oxide species will have much different sublimation temperatures than the phosphine mono oxide and phosphine species, even though the bridging groups and outer groups may be the same. The sublimed species also have different physical appearances, further simplifying the process. Accordingly, the reasons successive sublimation is preferred are fairly straightforward. It is effective at producing the required degree of purification, it generally requires no additional solvents or other materials be introduced into the process, and it generally generates a minimum amount of waste. However, while sublimating each of phosphine oxide, partially oxidized phosphine oxide, and phosphine species is an effective method for producing phosphine oxide materials of acceptable purity, any method that produces substantially the same result; a substantially purified phosphine oxide, should be understood as being encompassed by the present invention. Further, it should be understood that the successive sublimation that produces the diphosphine oxide species of the present invention, must be performed much more carefully and slowly than is typical. Rapid heating and/or poor vacuum in the sublimation process will not produce the purity required for the present invention, even though the substance may appear to be pure using standard chemical characterization techniques, such as thin layer chromatography, high pressure liquid chromatography, NMR, and elemental analysis. Accordingly, as used herein, it should be understood that a phosphine oxide has been “substantially purified” when it will no longer produce any phosphine structures that are not fully oxidized at the phosphine moiety that are detectable by NMR when the mixture has been heated to a temperature above the sublimation temperature of the non-oxidized phosphine structures, but below the sublimation temperature of the phosphine oxide at a vacuum of at least 10⁻⁶ Torr and for a period of at least 24 hours. As will be recognized by those having ordinary skill in the art, the process of producing the “substantially pure” phosphine oxides of the present invention will typically remove many other undesirable impurities, and other chemical techniques can and should be used to remove such impurities. However, for purposes of defining “substantially pure,” these other impurities should not be viewed as limiting the scope of the present invention. Further, while successive sublimation is typically required to produce the requisite purity, it may not be used at all, or it may be used in conjunction with other standard chemical separation procedures such as column chromatography. The inventors have determined that column chromatography followed by successive sublimation is an efficient and effective separation regime to produce materials of the requisite purity.

As will be recognized by those having ordinary skill in the art, certain polymeric and large oligomeric molecules are not amenable to vacuum sublimation but are still useful as a thin film circuit element when applied by solution-based coating techniques such as spin-coating or printing. The purification requirements for such materials is generally similar to those described above, with the exception that purification is performed on the precursor monomer or oligomer before assembly of the final phosphine oxide.

One of the principle advantages of the present invention is that by selecting appropriate bridging and outer groups, the new class of materials of the present invention enables designers to “tune” the electrical and electroluminescent characteristics of the materials. Generally, aromatic, heteroaromatic, alicyclic and aliphatic compounds may be used for the bridging group and for the outer groups. The bridging group can also include one or more phosphine oxide moieties, each bonded to an organic molecule. The particular selection of each will determine the electrical and luminescent properties of a specific material. Accordingly, the materials may be viewed as “tunable” meaning that a material with particular photophysical properties (such as triplet exciton energy) may be synthesized for use in a particular application which requires that property. This is a result of the fact that the phosphine oxide moiety restricts electron conjugation between the bridging and outer groups, and between the outer groups themselves. The fact that the bridging and outer groups are isolated from each other, allows the photophysical properties of the bridging and outer groups to be maintained in the molecule. The lowest energy component (bridging group or outer group) will define the triplet state and highest occupied molecular orbital energies for the entire molecule. Accordingly, a specific requirement for a material may be met by choosing the appropriate bridging and outer groups, without having to consider the electrical interaction between the two. The present invention is therefore this entire class of materials, as the discovery of this isolating property of the phosphine oxide moiety has enabled a broad range of materials to be tuned to a wide variety of specific applications. For example, materials such as naphthalene or biphenyl whose wide bandgap and high triplet state energies are desirable, but whose physical properties are unsuitable for practical device applications, can be combined and incorporated into the materials of the present invention, preserving their desirable photophysical properties (wide bandgap and high triplet state energies) while making them physically amenable to practical device applications, including but not limited to, thin film formation.

While not meant to be limiting, the use of the materials of the present invention as charge transporting host materials in organometallic phosphor-doped electroluminescent devices provides an excellent example of how the phosphine oxide materials may be “tuned” for a specific application. For example, a material suitable as a charge transporting host for a blue phosphorescent OLED is achieved by selecting the bridging group as octafluorobiphenyl and all outer groups as phenyl to give 4,4′-bis(diphenylphosphine oxide) octafluorobiphenyl (shown as PO5 in FIG. 3). The bridging group is thus the lowest energy group attached to the phosphine oxide moieties, and the triplet state energy of PO5 is almost identical to octafluorobiphenyl (Et=2.92 eV). Thus, the melting point of the overall molecule is much higher than the octafluorobiphenyl, while the triplet energy of the octafluorobiphenyl is preserved.

Materials suitable as charge transporting hosts for green phosphorescent OLEDs can be achieved, for example, by selecting the bridging group as biphenyl and all outer groups as phenyl to give 4,4′-bis(diphenylphosphine oxide)biphenyl (shown as PO1 in FIG. 3). Another example of a green phosphorescent OLED is engineered when the bridging group is selected as biphenyl and the outer groups are selected as phenyl and 1-naphthyl to give 4,4′-bis(1-naphthylphenylphosphine oxide)biphenyl (shown as PO8 in FIG. 3). For PO1, the bridging group is the lowest energy group attached to the phosphine oxide moieties, and the triplet state energy of PO1 is almost identical to biphenyl (Et=2.8 eV). For PO8, the outer group 1-naphthyl is the lowest energy group attached to the phosphine oxide moieties, and the triplet state energy of PO8 is almost identical to naphthalene (Et=2.6 eV). As with the blue OLED, tuning the materials in this manner achieves a material exhibiting similar photophysical properties to naphthalene, but with a much higher melting point (naphthalene 80° C., PO8 313° C.). Suitable outer groups include, but are not limited to, aryl, heteroaryl, cycloalkyl, or alkyl groups, as well as, R-substituted derivatives of these groups, where the substituted derivative is an alkyl, aryl, heteroaryl, halo, amino, hydroxyl, alkoxy, cyano, halogenated alkyl, aryl or heteroaryl. Preferred outer groups are shown in FIG. 4 wherein x denotes a repeating unit, and can be an integer between 1 and 6. These outer groups can be used alone or in combinations to form the phosphine oxide structures shown FIGS. 1 and 2.

Suitable bridging groups therefore include, but are not limited to, aryl, heteroaryl, cycloalkyl, or alkyl groups. Preferred bridging groups include, but are not limited to, difunctional or multifunctional groups (i.e., substituted at two or more positions) and selected from benzene, naphthalene, pyrene, stilbene, diphenylethyne, pyridine, quinoline, thiophene, phenylene vinylene, thienylene vinylene, biphenyl, diphenylmethane, bithiophene, bipyridine and substituted versions with R as defined above. Specific examples are shown in FIG. 5 wherein x denotes a repeating unit, and can be an integer between 1 and 6.

### BRIEF DESCRIPTION OF THE SEVERAL VIEWS OF THE DRAWING

FIG. 1 is a schematic drawing of a general structure of the mono phosphine oxide embodiment of the present invention.

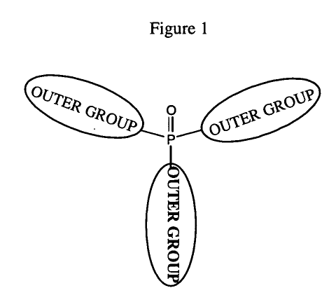

FIG. 2 is a schematic drawing of the general structure of the di phosphene oxide and tri phosphene oxide embodiment of the present invention.

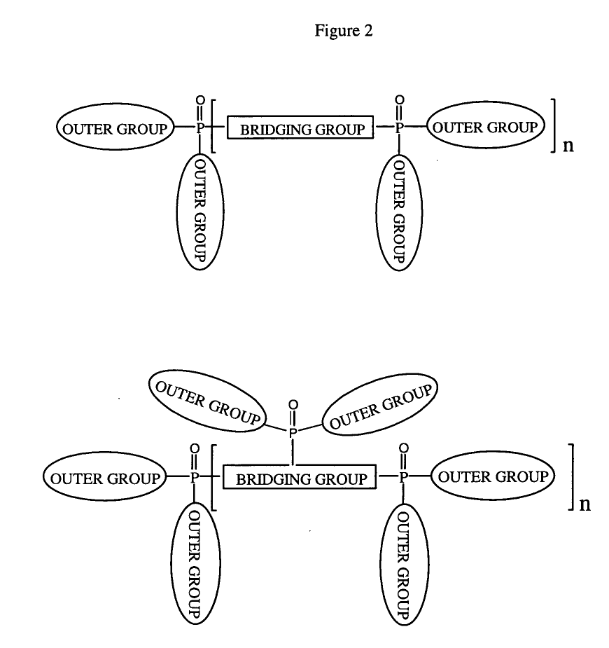

FIG. 3 shows examples of structures tuned to be used as the conductive host in blue and green organometallic phosphor doped OLED in accordance with the present invention.

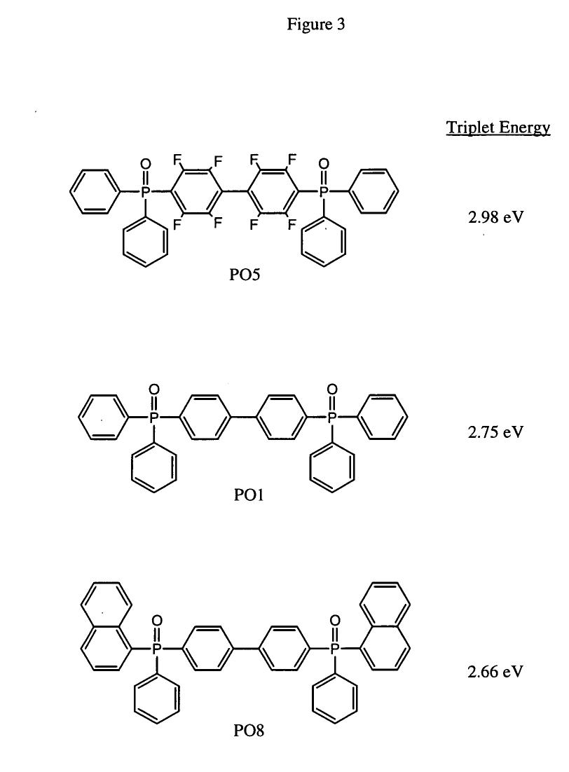

FIG. 4 shows the structures of preferred outer groups utilized in the present invention.

FIG. 5 shows the structures of preferred bridging groups utilized in the present invention.

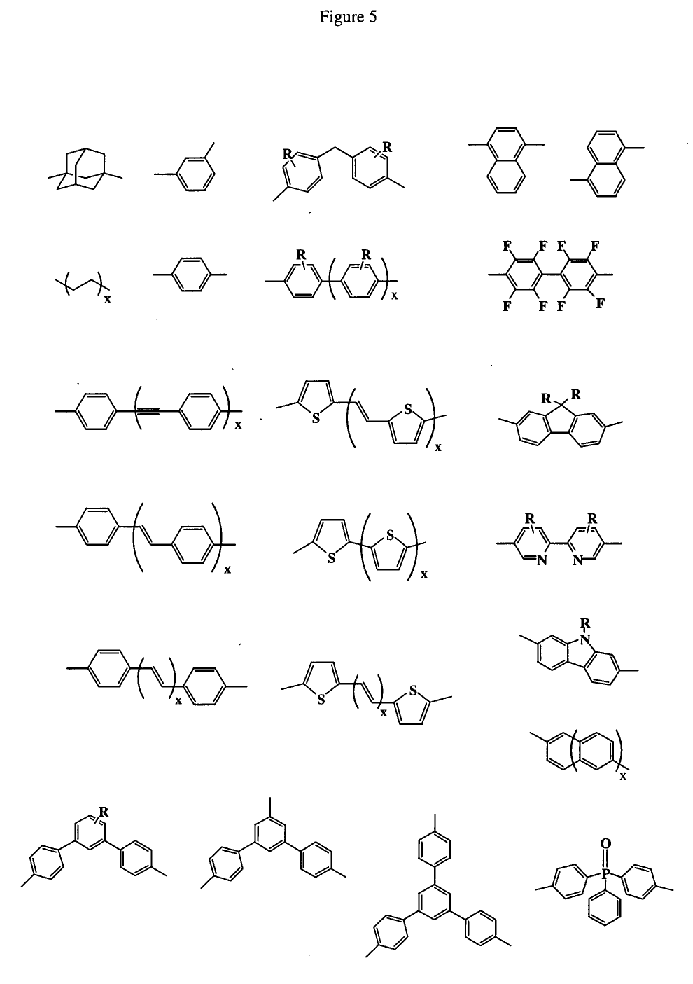

FIG. 6 is a series of graphs showing the normalized absorption, phosphorescence and emission intensities as a function of wavelength for a preferred embodiment of the present invention (4,4′-bis(diphenylphosphine oxide)biphenyl) in a variety of differing configurations. (a) is the absorption spectrum in CH₂Cl₂; (b) is the emission spectrum in CH₂Cl₂; (c) is the emission spectrum in 2-MeTHF at 77K; (d) is the phosphorescence spectrum in 2-MeTHF at 77K; (e) is the absorption spectrum of 4,4′-bis(diphenylphosphine oxide)biphenyl film on quartz; (f) is the emission spectrum of 4,4′-bis(diphenylphosphine oxide)biphenyl film on quartz; and (g) is the EL spectrum of a device with the structure—ITO/200 Å CuPc/400 Å 4,4′-bis(diphenylphosphine oxide) biphenyl/10 Å LiF/1000 Å Al.

FIG. 7 is a graph of current density verses voltage from a preferred embodiment of the present invention composed of: ITO/200 Å CuPc/400 Å PO1/10 Å LiF/1000 Å AI.

FIG. 8 is a comparison of (a) computed structures for PO1 and DDB and orbital amplitude plots of their (b) LUMO and (c) HOMO.

### DETAILED DESCRIPTION OF THE INVENTION

The following experiment demonstrated how one preferred embodiment of the present invention was successfully utilized as the active component of an electronic device. Specifically, the photoluminescent and electroluminescent properties of 4,4′-bis(diphenylphosphine oxide)biphenyl (hereafter PO1) demonstrated how the phosphine oxide moieties of the present invention restrict electron conjugation and provide a wide optical gap, electron transporting material. These properties of this new material provide superior performance to the more widely studied diamine analogue which is hole transporting and exhibits a smaller optical gap.

PO1 was obtained by oxidation of 4,4′-bis(diphenylphosphine)biphenyl (P1). The synthesis was performed as follows. All chemicals were obtained from Aldrich Chemical Co. and used as received unless noted otherwise. THF was distilled from Na metal/benzophenone. All glassware was thoroughly dried prior to use. 4,4′-bis(diphenylphosphine)biphenyl (P1) [CAS # 4129-44-6] was formed by providing a 250 mL, 3-neck round bottom flask equipped with a stir bar and thermometer filled with argon. The flask was charged with 3.21 g [0.01 moles] of 4,4′-dibromobiphenyl and 90 mL of freshly distilled THF. Once all the 4,4′-dibromobiphenyl had dissolved the mixture was cooled to −66° C. n-Butyl lithium [0.02 moles] was added dropwise using a syringe. Once the addition was completed, stirring was continued another hour at −66° C. after which the reaction mixture was allowed to warm up and stabilize at 0° C. for a 3-hour period. The reaction flask was cooled again to −66° C. prior to addition of 3.58 ml chlorodiphenylphosphine [0.02 moles] by syringe. As the addition was completed the color of the reaction mixture became pale yellow. The mixture was allowed to stir for 3 hours at −66° C. before gradual warming to room temperature overnight. The reaction was then quenched with 2 mL of degassed methanol and all volatiles removed under reduced pressure. The crude white solid obtained was dissolved in degassed CH₂Cl₂ and immediately filtered through a short column of Celite (under nitrogen atmosphere). The CH₂Cl₂ was removed and the white solid was digested in degassed ethanol and gravity filtered affording 4.70 g of crude P1. A silica column was used with CH₂Cl₂ as the solvent to separate the P1 (R_{f}−0.99) from its monoxide (R_{f}−0.03). Removal of volatile solvents under vacuum resulted in 4.16 g of chemically pure P1 (80%).

The resultant material was characterized as follows. NMR spectra were obtained using a Bruker AMX400 spectrometer at the following frequencies: 400.1 MHz (¹H), 161.9 MHz (³¹P) 100.6 MHz (¹³C). Signals observed in the ¹H and ¹³C spectra were referenced to internal TMS and CDCl₃ and the ³¹P signals were externally referenced to 85% H₃PO₄. IR spectra of samples prepared as KBr pellets were obtained using a Nicolette: Magna IR 860 Spectrometer. Melting points of chemically pure materials were determined by differential scanning calorimetry (DSC) using a Netzsch simultaneous thermal analyzer (STA400) with a heating rate of 20 □C/min under N2 gas. Indium metal was used as the temperature standard. Elemental analysis was performed by Desert Analytics Laboratories, Tucson, Ariz. USA. The findings, and comparisons with literature values, were as follows: Mp: 195° C. (DSC) (mp 192.5° C.-194° C.). Anal. calc. for C₃₆H₂₈P₂: C, 82.74; H, 5.40; found: C, 82.73; H, 5.42. ¹H NMR (CDCl₃, 295 K): □0.7.56 (m, 4H), 7.3-7.4 (24H). ¹³C{¹H} NMR (CDCl₃, 295 K): □ 140.74 (s, 1/1′, 2C), 137.30 (d, ¹J_{PC}=12 Hz, ipso-Ph, 4C), 136.1 (d, 4/4′, ¹J_{PC}=12 Hz 2C), 134.19 (d, ²J_{PC}=18 Hz, 3/3′, 4C), 133.78 (d, ²J_{PC}=18 Hz, o-Ph, 8C), 128.8 (s, p-Ph, 4C), 128.56 (d, ³J_{PC}=7 Hz, m-Ph, 8C), 127.06 (d, ³J=7 Hz, 2/2′, 4C). ³¹P NMR (CDCl₃, 295 K); □-5.62. IR (KBr pellets): ν (cm⁻¹) 1432, 1003 (m); P—C (str.); 1475 C═C (str.).

4,4′-bis(diphenylphosphine oxide)biphenyl (PO1) [CAS # 4129-45-7] was then synthesized from the P1 by taking a 100 mL round bottomed flask charged with 3.0 g of P1 [0.0057 mol], 30 mL of CH₂Cl₂, and 10 mL of 30% hydrogen peroxide. After stirring the reaction mixture overnight, the organic layer was separated, washed with water and then brine. The combined extracts were evaporated to dryness affording a white solid. The unreacted P1 (R_{f}−0.85) and the mono oxide (R_{f}−0.38) were removed by column chromatography (SiO₂: ethyl acetate/hexanes/methanol—2:3:0.3) to yield 3.10 g of chemically pure PO1 (97%). The same analytical procedure used for the P1 was then conducted, providing the following results: Mp. 313° C. (DSC) (mp 299.0° C.-301.5° C.). Anal. calc. for C₃₆H₂₈P₂O₂: C, 77.97; H, 5.09; found: C, 78.07; H, 5.00. ¹H NMR (CDCl₃, 295 K) □7.79 (m, 4H), 7.71 (m, 12H), 7.57 (m,4H), 7.48 (m,8H). 13C{1H} NMR (CDCl₃, 295 K): □ 143.35 (s, 1/1′, 2C), 132.92 (d, ²J_{PC}=10 Hz, 3/3′, 4C), 132.46 (d, ¹J_{PC}=101 Hz, ipso-Ph, 4C) 132.40 (d, ¹J_{PC}=101 Hz, 4/4′, 2C), 132.20 (d, ²J_{PC}=10 Hz, o-Ph, 8C) 132.04 (s, p-Ph, 4C), 128.59(d, ³J_{PC}=15 Hz, m-Ph, 8C), 127.30 (d, ³J_{PC}=15 Hz, 2/2′, 4C). ³¹P NMR (CDCl₃, 295 K): □ 29.07. IR (KBr pellets): ν (cm⁻¹) 1188 P═O str.; 1439, 1001 (m) P—C (str.); 1485 (m); C═C (str.).

Treatment of P1 with hydrogen peroxide even for extended time periods did not afford complete conversion to PO1. TLC indicated the presence of both the diphosphine and phosphine monoxide. Notably, following column chromatography these impurities were no longer detectable by ³¹P NMR and TLC, yet, both impurities were separated and identified from the lower temperature fractions (150-170° C., base pressure 10. Torr for a period of 24 hours) following further purification by high vacuum, gradient temperature sublimation. Three sublimations were performed prior to photophysical and device studies in order to ensure removal of these impurities.

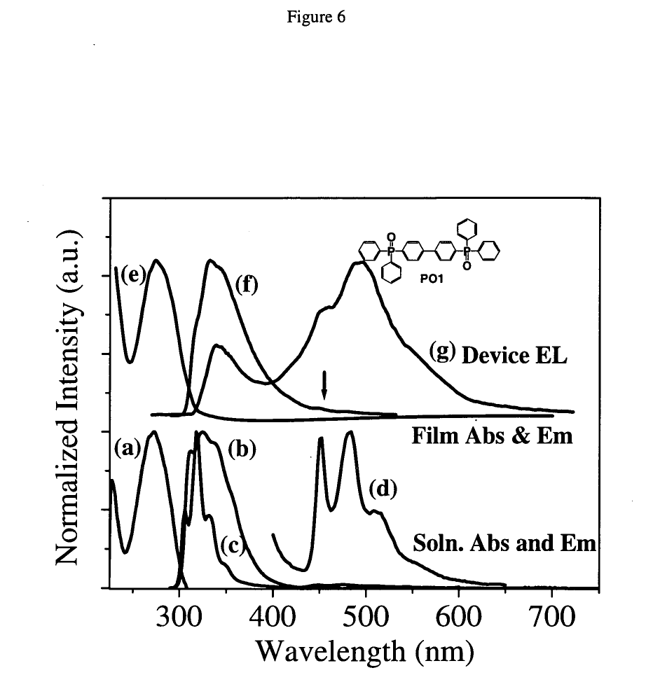

The absorption and luminescence spectra of PO1 are presented in FIG. 6. The absorption maximum is 272 nm both in solution (CH₂Cl₂, log ε=4.57) and a vapor deposited film as shown in FIGS. 6a and 6e, respectively, which is significantly blue shifted (83 nm) from the corresponding diamine, 4,4′-bis(diphenylamine)biphenyl (DDB). While DDB is reported to emit at 395 nm, excitation of PO1 in solution results in efficient deep UV emission (λₘₐₓ=325 nm, φ_{fl}=0.74, τ=0.58 ns), which is slightly red shifted (332 nm) and broadened in the vapor deposited film as shown in FIG. 6f.

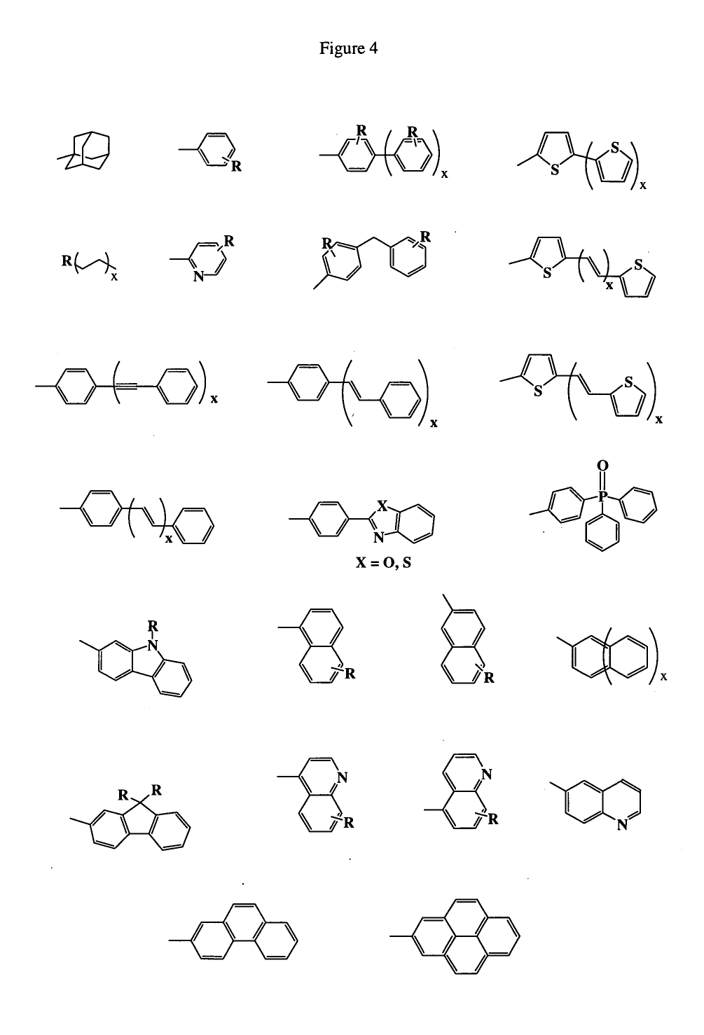

As shown in FIG. 6c, cooling PO1 to 77K in 2MeTHF enhances the emission vibrational fine structure, shifts the fluorescence maximum to 318 nm and reveals additional peaks at 451, 483, and 511 nm as shown in FIG. 6d. The radiative lifetime was measured using time-resolved fluorimetry and was 1.5±0.1 s for the blue emission consistent with phosphorescence. Weak blue emission from the solid state film at room temperature was also observed at 450 and 478 nm, as shown by the arrow in FIG. 4f. This is similar to previous reports of weak spin-orbital coupling in tris[p-(N-7-azaindoly)phenyl]phosphine resulting in room temperature blue phosphorescence in the solid state reported by Kang, Y.; Song, D.; Schmider, Wang, S. Organometallics 2002, 21, 2413.

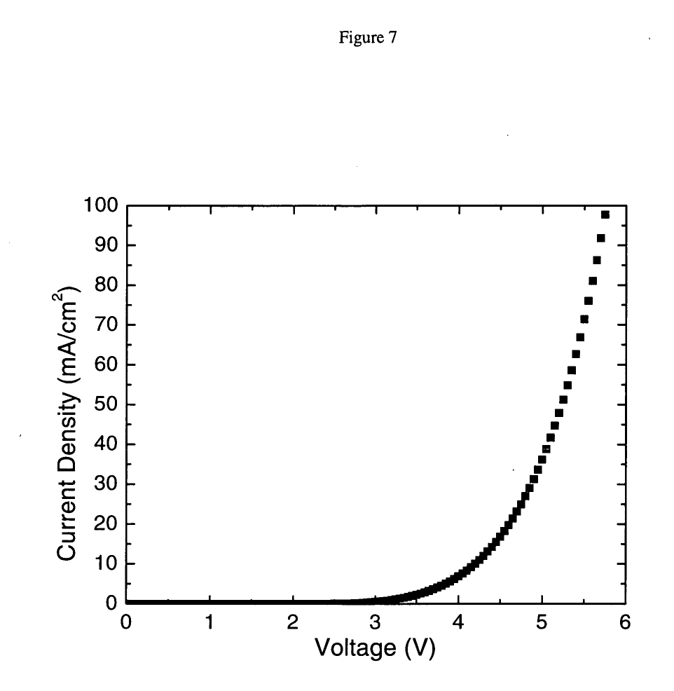

The EL spectrum of a simple bilayer OLED grown by vacuum evaporation on indium tin oxide coated glass using PO1 as the active emissive layer is shown in FIG. 6g. The procedure for preparing the OLED is as follows. On a commercially available indium tin oxide substrate, a simple bilayer electroluminescent device was grown by vacuum evaporation consisting of, in sequence, a 200 Å thick layer of copper phthalocyanine (CuPc), a 400 Å thick layer of PO1 and a cathode consisting of a 10 Å LiF layer followed by a 1000 Å Al layer. The cathode was deposited through a stencil mask to yield circular devices 1 mm in diameter. A quartz crystal oscillator placed near the substrate was used to measure the thickness of the films, which were calibrated ex situ using ellipsometry. Devices were tested in air with an electrical pressure contact made by means of a 25 μm diameter Au wire. Current-voltage characteristics were measured with an Agilent Technologies 4155B semiconductor parameter analyzer and EL spectra were recorded with an EG&G optical multichannel analyzer on a 0.25 focal length spectrograph. A graph of the measured current density verses voltage is shown as FIG. 7.

Absorbance spectra were recorded with a Shimadzu UV-2501PC Ultraviolet-Visible (UV-Vis) dual-beam spectrometer. Room temperature emission spectra were recorded using a Jobin-Yvon SPEX Fluorolog 2 (450-W Xe lamp) at an excitation wavelength of 270 nm. All solution photophysical studies were conducted on dilute samples (optical density ˜0.1-0.2) to prevent self-absorption. Quantum yields were determined according to the method described by Demas, N. J.; Crosby, G. A. in the J. Phys. Chem., 1971, 75, 991 relative to quinine sulfate in 1.0N H₂SO₄ (Q_{R}−0.546).

The singlet lifetime in CH₂Cl₂ was determined using the output of a frequency-doubled picosecond dye laser pumped by the second harmonic (280 nm) of a mode-locked Nd:Vanadate laser (76 MHz) directed onto the sample where light emission was collected at right angles and focused into a ⅛ meter subtractive double monochromator equipped with a microchannel plate PMT operating in pulse-counting mode. The time resolution of the apparatus was measured to be 50 psec FWHM using a standard scattering material. Low temperature (77K) emission spectra and triplet lifetime were obtained in 2-methyltetrahydrofuran on a PTI QuantaMaster model C-60SE spectrofluorometer, equipped with a 928 PMT detector and corrected for detector response.

With the cathode biased negative with respect to the anode, EL in the UV (338 nm) and the blue (452 and 495 nm) spectral regions was measured at low voltage (10 mA/cm² injected current at 4.2V). While an exact quantification of the EL quantum efficiency was impractical due to low detector efficiency at <350 nm and absorption in the glass and CuPc layers, it is estimated at <0.1%. The low efficiency is consistent with strong intersystem crossing to the long-lived triplet state leading to quenching of the radiative excitons. However, similar long-lived states have been previously shown to efficiently transfer to short-lifetime phosphorescent dopants to give high device efficiencies as shown in Adachi, C.; Kwong, R. C.; Djurovich, P.; Baldo, M. A.; Thompson, M. E.; Forrest, S. R. Appl. Phys. Lett. 2001, 79, 2082. No light emission was observed when the cathode was biased positively with respect to the anode, suggesting that PO1 transports electrons and blocks holes. Electrochemical analysis by cyclic voltammetry (DMF vs. ferrocene/ferrocenium couple) was preformed and supported this conclusion, since PO1 was shown to reversibly accept an electron at the P═O moiety as does triphenylphosphine oxide, reported by Santhanam, D. S. V. and Bard, A. J. J. Am. Chem. Soc. 1968, 90, 1118. The first reduction potential was −2.33 V (reversible), and is in the same range as the measured reduction potentials of the electron transporting aluminum tris(8-hydroxyquinolato) (Alq₃) (−2.23 V, irreversible) and hole blocking material, bathocuproine (BCP) (−2.53 V, irreversible). In contrast, triaryl amines are preferentially hole transporting with higher reduction potentials.

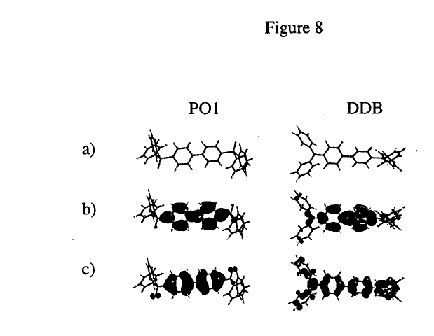

The difference in properties between PO1 and DDB can be understood by examining the geometry and electronic structure of both materials in terms of bridging aryl (biphenyl) and outer aryl (phenyl) group domains separated by P═O or N moieties. The computed structures for PO1 and DDB are shown in FIG. 8a. The N centers are trigonal planar allowing interaction of the nitrogen electron lone pairs with the bridging and outer aryl rings. In contrast, the distorted tetrahedral geometry and absence of available lone pair electrons on the phosphorus site prevents electron delocalization between the two aryl domains. Molecular orbital analysis clearly shows that the P═O group restricts conjugation by confining the highest occupied and lowest unoccupied molecular orbitals (HOMO and LUMO) to the biphenyl bridge, while the N group conversely contributes to a delocalized electronic structure (see FIGS. 8b and 8c). These results are consistent with the lack of electronic interaction between phenylacetylenyl arms through a P═O center reported by Metivier, R.; Amengual, R.; Leray, I.; Michelet, V.; Genêt, J.-P., Org. Lett. 2004, 6, 739.

These changes are also reflected in computed HOMO/LUMO energies and their difference compared to the experimental optical gap in Table 1.

TABLE 1
Calculated (B3LYP/6-31G*) HOMO/LUMO Energies
(eV) and Experimental Optical Gap (eV)

| | | | HOMO/LUMO | Optical |
|---|---|---|---|---|
| Compound | HOMO | LUMO | Energy Gap | Gap* |
| PO1 | −6.694 | −1.769 | 4.925 | 4.58 |
| DDB | −4.980 | −1.197 | 3.782 | 3.49⁹ |

*Determined from the lowest energy absorption maximum.

The large blue shift in absorption and emission energies of PO1 compared to DDB can be qualitatively attributed to a significant deepening of the occupied manifold (˜1.7 eV HOMO energy) and slight lowering of the virtual manifold (˜0.6 eV LUMO energy) resulting in a widening of the optical gap by >1 eV.

These results thus provide an example of the present invention used as the active layer in an OLED, and show that the P═O moieties of PO1 restrict conjugation between bridging and outer aryl groups, thus widening the optical energy gap of the material. While other chemical moieties can be used to break conjugation and increase the bandgap, as shown in Ren, X.; Li, J.; Holmes, R. J.; Durovich, P. I.; Forrest, S. R.; Thompson, M. E. Chem. Mater. 2004, 16, 4743, the electrochemical properties of the P═O center and the preliminary OLED characteristics suggest the added property of facile electron transport. The combination of high exciton energy and electron transport suggests that further development of triaryl diphosphine oxide compounds may offer a novel set of organic electronic transport materials with tuneable bandgaps for applications in organic electronic devices, particularly as host materials for more efficient, shorter radiative lifetime blue electrophosphorescent dopants.

### CLOSURE

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

1) A material comprising one or more phosphine oxide moieties each of said phosphine moieties further bonded by single bonds to at least two outer groups, said material substantially purified and configured as part of a circuit.

2) The material of claim 1 further comprising two or more phosphine oxide moieties joined by a bridging group, wherein each of said phosphine oxide moieties is further bonded by single bonds to two outer groups, said material substantially purified and configured as part of a circuit.

3) The material of claim 2 wherein said bridging group is selected from the group consisting of aryl, heteroaryl, cycloalkyl, and alkyl groups, difunctional or multifunctional groups bonded to said phosphine oxide moieties at two or more positions and selected from benzene, naphthalene, pyrene, stilbene, diphenylethyne, pyridine, quinoline, thiophene, phenylene vinylene, thienylene vinylene, biphenyl, diphenylmethane, bithiophene, bipyridine and substituted derivatives where the substituted group is an alkyl, aryl, heteroaryl, halo, amino, hydroxyl, alkoxy, cyano, halogenated alkyl, aryl or heteroaryl group, and combinations thereof.

4) The material of claim 1 wherein said outer groups are selected from the group consisting of aryl, heteroaryl, cycloalkyl, and alkyl groups, and R-substituted derivatives of aryl, heteroaryl, cycloalkyl, and alkyl groups, where R is an alkyl, aryl, heteroaryl, halo, amino, hydroxyl, alkoxy, cyano, halogenated alkyl, aryl or heteroaryl group.

5) The material of claim 1 and 2 wherein said outer groups are identical.

6) An organic light emitting device having an anode layer, a cathode layer, and at least one organic layer interposed between the anode and cathode layer, wherein at least one of said organic layers comprises:
a. a substantially purified material having two or more phosphine oxide moieties joined by a bridging group, wherein each of said phosphine moieties is further bonded by single bonds to two outer groups.

7) The organic light emitting device of claim 6 wherein said substantially purified material is a charge transport material.

8) The organic light emitting device of claim 7 wherein said charge transport material emits light in response to an external stimulus.

9) The organic light emitting device of claim 7 wherein said charge transport material further contains at least one dopant.

10) The organic light emitting device of claim 9 wherein said charge transport material works in conjunction with said at least one dopant to emit light in response to an external stimulus.

11) The organic light emitting device of claim 9 where the light is emitted substantially from the dopant.

12) The organic light emitting device of claim 7 wherein said substantially purified material functions as a charge blocking material.

13) The organic light emitting device of claim 7 wherein said substantially purified material functions as an exciton blocking material.

14) The organic light emitting device of claim 7 wherein said substantially purified material is a dopant in one of said organic layers and emits a phosphorescent or fluorescent response to an external stimulus.

15) The material of claim 1 and 2 wherein the circuit is a photodetector.

16) The material of claim 1 and 2 wherein the circuit is a solar cell.

17) The material of claim 1 and 2 wherein the circuit is a thin film transistor.

18) The material of claim 1 and 2 wherein the circuit is a bipolar transistor.

19) The material of claim 1 and 2 wherein the circuit is incorporated in an array to form an information display.
